(19) United States
(12) Patent Application Publication
(10) Pub. No.: US 2024/0142864 A1
(43) Pub. Date: May 2, 2024

(54) PROJECTION DEVICE

(71) Applicant: Coretronic Corporation, Hsin-Chu (TW)

(72) Inventors: Wen-Jui Huang, Hsin-Chu (TW); Wei-Yi Lee, Hsin-Chu (TW); Wen-Hao Chu, Hsin-Chu (TW)

(73) Assignee: Coretronic Corporation, Hsin-Chu (TW)

(21) Appl. No.: 18/488,038

(22) Filed: Oct. 17, 2023

(30) Foreign Application Priority Data
Oct. 26, 2022 (CN) 202211316101.0

(51) Int. Cl. G03B 21/16; G03B 21/14

(52) U.S. Cl. CPC G03B 21/16; G03B 21/145

(57) ABSTRACT

A projection device includes a casing, a light source module, a light valve module, a projection lens, a heat dissipation module, and a fan disposed in the casing. The casing has at least one air inlet, a first air outlet, and a second air outlet. The heat dissipation module is coupled to the light source module and the light valve module and configured to cool the light source module and the light valve module. The fan has a first air exhaust and a second air exhaust. The first air exhaust and the second air exhaust are respectively disposed at positions adjacent to the first air outlet and the second air outlet of the casing.

### CROSS-REFERENCE TO RELATED APPLICATION

This application claims the priority benefit of China application serial no. 202211316101.0, filed on Oct. 26, 2022. The entirety of the above-mentioned patent application is hereby incorporated by reference herein and made a part of this specification.

### BACKGROUND OF THE INVENTION

### Field of the Invention

The invention relates to a projection device.

### Description of Related Art

In the current projection device market, it has become a trend to pursue thinner projection devices. In the projection device, a fan having a single air exhaust is usually selected to provide heat dissipation airflow. However, since the thinned projection device is limited by the thickness of the casing, the size of the air exhaust of the fan is also limited, resulting in reduced air flow. Moreover, if an air duct and a plurality of air outlets are added to the casing of the projection device in order to increase the area of the air outlets of the projection device, the volume of the projection device is increased instead. Furthermore, the secondary air outlet on the casing also generates additional impedance due to not directly facing the air exhaust of the fan, thereby reducing the heat dissipation effect. In addition, if the number of the fans is changed to a plurality, the volume and cost of the projection device are also increased.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a projection device with good heat dissipation capability.

Other objects and advantages of the invention may be further understood from the technical features disclosed in the invention.

To achieve one or part or all of the above objects or other objects, a projection device of the invention includes a casing and a light source module, a light valve module, a projection lens, a heat dissipation module, and a fan disposed in the casing. The light source module is configured to provide an illumination beam. The light valve module is disposed on a transmission path of the illumination beam and configured to convert the illumination beam into an image beam. The projection lens is disposed on a transmission path of the image beam and configured to project the image beam out of the projection device. The casing has at least one air inlet, a first air outlet, and a second air outlet. The heat dissipation module is coupled to the light source module and the light valve module and configured to cool the light source module and the light valve module. The fan has a first air exhaust and a second air exhaust, and the first air exhaust and the second air exhaust are respectively disposed at positions adjacent to the first air outlet and the second air outlet of the casing.

In an embodiment of the invention, the heat dissipation module includes a first heat dissipation structure and a second heat dissipation structure. The first heat dissipation structure is coupled to the light source module. The second heat dissipation structure is coupled to the light valve module.

In an embodiment of the invention, the at least one air inlet includes a first air inlet and a second air inlet, and the first heat dissipation structure is disposed at a position adjacent to the first air inlet of the casing. The second heat dissipation structure is disposed at a position adjacent to the second air inlet of the casing.

In an embodiment of the invention, areas of the first air exhaust and the second air exhaust are different.

In an embodiment of the invention, areas of the first air exhaust and the second air exhaust are the same.

In an embodiment of the invention, the projection device further includes a pillar. The fan also has a first air intake and a second air intake. The fan is connected to the casing via the pillar.

In an embodiment of the invention, an area of the first air intake and an area of the second air intake are different.

In an embodiment of the invention, the casing includes an upper cover portion, a lower cover portion, and a side cover portion connected between the upper cover portion and the lower cover portion. The upper cover portion and the lower cover portion are arranged in parallel. The fan includes a first surface and a second surface respectively corresponding to and parallel to the upper cover portion and the lower cover portion. The first air intake and the second air intake are respectively located on the first surface and the second surface.

In an embodiment of the invention, a distance from the first surface to the upper cover portion is a first distance. A distance from the second surface to the lower cover portion is a second distance. A ratio of the first distance to the second distance is 0.8 times to 1.2 times a ratio of the area of the first air intake to the area of the second air intake.

In an embodiment of the invention, the areas of the first air inlet and the second air inlet are greater than the areas of the first air outlet and the second air outlet.

In an embodiment of the invention, the casing includes an upper cover portion, a lower cover portion, and a side cover portion connected between the upper cover portion and the lower cover portion. The first air inlet, the first air outlet, the second air inlet, and the second air outlet are respectively located on the side cover portion. The side cover portion includes a front cover and a rear cover parallel to each other, and a left cover and a right cover parallel to each other. A range of an orthographic projection of the first air exhaust at the front cover is at least partially overlapped with a range of orthographic projections of the first air inlet and the first air outlet at the front cover.

In an embodiment of the invention, a range of an orthographic projection of the second air exhaust at the left cover is at least partially overlapped with a range of orthographic projections of the second air inlet and the second air outlet at the left cover.

In an embodiment of the invention, in the projection device, a thickness of the fan is less than a thickness of the heat dissipation module along a direction of gravity.

In an embodiment of the invention, the projection device further includes a partition. The fan has at least one air intake. The partition is disposed between the fan and the casing. The partition is configured to block an air exhaust area and an air intake area of the fan. The first air exhaust and the second air exhaust are located at the air exhaust area. At least one air inlet is located at the air intake area.

In an embodiment of the invention, the projection device further includes a circuit board. The casing includes an upper cover portion, a lower cover portion, and a side cover portion connected between the upper cover portion and the lower cover portion. The circuit board is disposed between the upper cover portion and the fan.

In an embodiment of the invention, the fan also has a first air intake. The casing includes an upper cover portion, a lower cover portion, and a side cover portion connected between the upper cover portion and the lower cover portion. The first air intake faces the upper cover portion. There is a distance between the first air intake and the upper cover portion.

In an embodiment of the invention, areas of the first air outlet and the second air outlet of the casing are greater than or equal to areas of the first air exhaust and the second air exhaust of the fan.

Based on the above, the embodiments of the invention have at least one of the following advantages or efficacies. In the projection device of the invention, via the structural configuration of the casing and the fan, the double air exhausts (i.e., the first air exhaust and the second air exhaust) of the fan are respectively disposed at positions adjacent to the double air outlets (i.e., the first air outlet and the second air outlet) of the casing, and by optimizing the flow field path in the casing while maintaining the volume of the thin casing, the air flow resistance in the casing may be effectively reduced and the air flow amount in the casing may be increased at the same time, so that the projection device has good heat dissipation capability.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an optical path of a projection device of an embodiment of the invention.

FIG. 2 is a schematic top perspective view of the projection device of FIG. 1.

FIG. 3 is a schematic side perspective view of the projection device of FIG. 1.

FIG. 4 is a schematic top perspective view of a projection device of another embodiment of the invention.

FIG. 5 is a schematic side perspective view of a projection device of another embodiment of the invention.

FIG. 6 is a schematic top perspective view of a projection device of another embodiment of the invention.

FIG. 7 is a schematic side perspective view of the projection device of FIG. 6.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

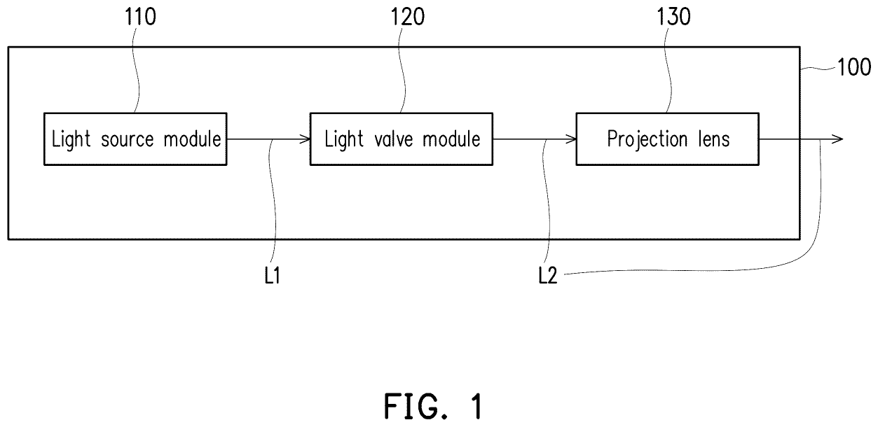

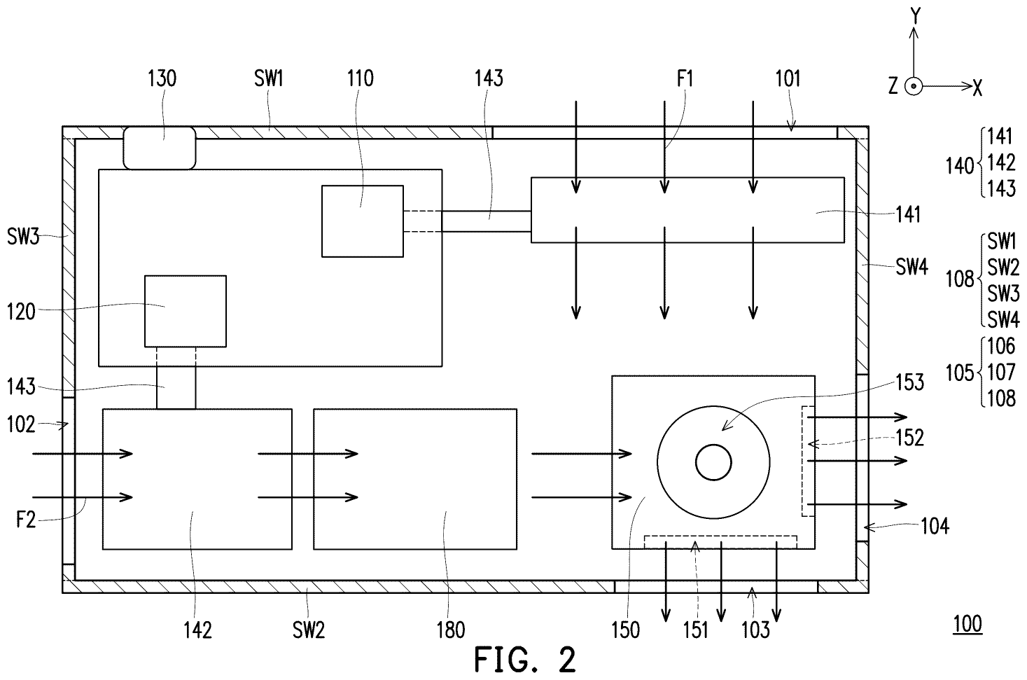

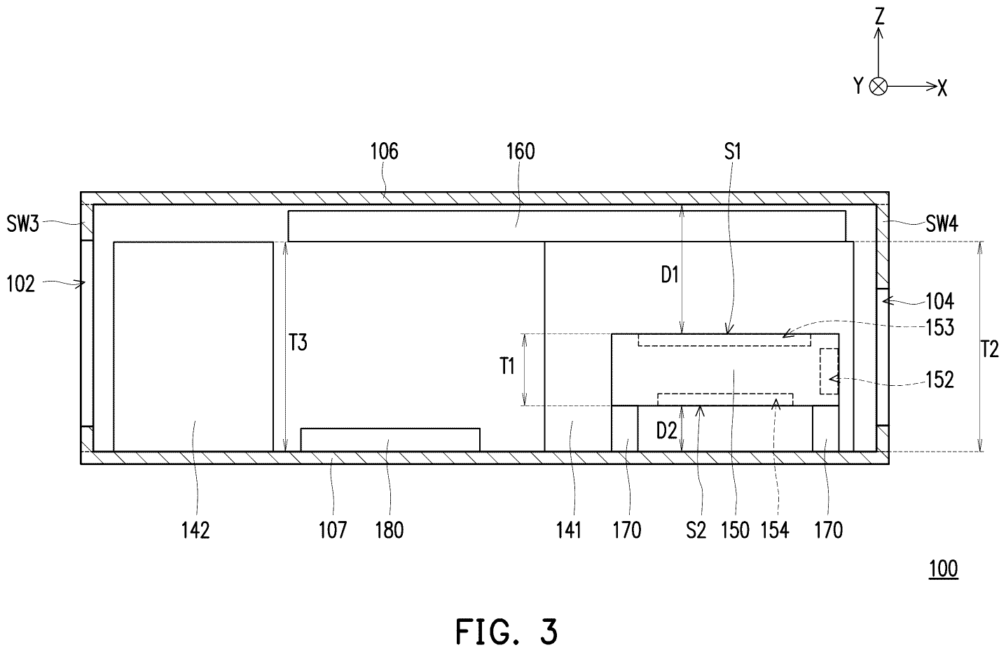

FIG. 1 is a schematic diagram of an optical path of a projection device of an embodiment of the invention. FIG. 2 is a schematic top perspective view of the projection device of FIG. 1. It should be noted that the Cartesian coordinates X-Y-Z are also provided here to facilitate related description and reference of subsequent members. The proportions of the dimensions, thicknesses, etc. of the members of a projection device 100 in the drawings are only for illustration. Moreover, in order to clearly illustrate the internal members of the projection device 100, a first circuit board 160 (shown in FIG. 3) is omitted in FIG. 2.

Referring to FIG. 1 and FIG. 2, the projection device 100 of the embodiment includes a light source module 110, a light valve module 120, and a projection lens 130. The light source module 110 is configured to provide an illumination beam L1. In an embodiment, the light source module 110 includes, for example, at least one light-emitting element, a wavelength conversion element, a light-homogenizing element, a light filter element, and at least one light guide element, and is configured to provide light beams with different wavelengths as the source of the illumination beam L1. The light-emitting element is formed by a single or a plurality of light-emitting diodes (LEDs) or laser diodes (LDs), but the invention does not limit the type or form of the light source module 110, and sufficient teaching, suggestion, and implementation of the detailed structure and implementation methods thereof may be obtained from common knowledge in the technical field, so details are not repeated herein.

The light valve module 120 is disposed on the transmission path of the illumination beam L1 and configured to convert the illumination beam L1 into an image beam L2. In an embodiment, the light valve module 120 is, for example, a liquid crystal on silicon (LCoS) panel or a digital micro-mirror device. In other embodiments, the light valve module 120 may be, for example, a high-temperature polysilicon liquid-crystal display (LCD), a transparent liquid-crystal panel, an electro-optical modulator, a magneto-optic modulator, or an acousto-optic modulator. The invention does not limit the configuration and the type of the light valve module 120.

The projection lens 130 is disposed on the transmission path of the image beam L2 and configured to project the image beam L2 out of the projection device 100. For example, the projection lens 130 includes, for example, a combination of one or a plurality of optical lenses having a diopter, including, for example, various combinations of a non-planar lens such as a biconcave lens, a biconvex lens, a concave-convex lens, a convex-concave lens, a plano-convex lens, a plano-concave lens, and the like. In an embodiment, the projection lens 130 may also include a flat optical lens projecting the image beam L2 from the light valve module 120 to the projection target in a reflective or transmissive manner. The projection target is, for example, a screen or a wall. The invention does not limit the configuration and the type of the projection lens 130.

Please refer to FIG. 2, in the embodiment, the projection device 100 further includes a casing 105, a heat dissipation module 140, and a fan 150. The light source module 110, the light valve module 120, the projection lens 130, the heat dissipation module 140, and the fan 150 are disposed in the casing 105. The heat dissipation module 140 is coupled to the light source module 110 and the light valve module 120 and configured to cool the light source module 110 and the light valve module 120. The casing 105 has at least one air inlet, a first air outlet 103, and a second air outlet 104. In the embodiment, the at least one air inlet includes a first air inlet 101 and a second air inlet 102. The fan 150 has a first air exhaust 151 and a second air exhaust 152, and the first air exhaust 151 and the second air exhaust 152 are respectively disposed at positions adjacent to the first air outlet 103 and the second air outlet 104 of the casing 105. More specifically, the first air exhaust 151 and the second air exhaust 152 are respectively disposed facing the first air outlet 103 and the second air outlet 104.

As described above, via the structural design of the casing 105 and the fan 150 of the projection device 100, the dual air exhausts (i.e., the first air exhaust 151 and the second air exhaust 152) of the fan 150 are respectively disposed at positions adjacent to the dual air outlets (i.e., the first air outlet 103 and the second air outlet 104) of the casing 105, thus achieving the effect of optimizing the flow field path in the casing 105. Moreover, under the condition of achieving a thinner casing 105, the air flow resistance inside the casing 105 may be effectively reduced and the airflow amount inside the casing 105 may be increased, so that the projection device 100 has good heat dissipation capability.

The internal members of the projection device 100 are further described below.

Referring to FIG. 2, in the embodiment, the heat dissipation module 140 includes a first heat dissipation structure 141 and a second heat dissipation structure 142, wherein the first heat dissipation structure 141 is coupled to the light source module 110, and the second heat dissipation structure 142 is coupled to the light valve module 120. The first heat dissipation structure 141 is disposed at a position adjacent to the first air inlet 101 of the casing 105, and the second heat dissipation structure 142 is disposed at a position adjacent to the second air inlet 102 of the casing 105. More specifically, no other members are disposed between the first heat dissipation structure 141 and the first air inlet 101. No other members are disposed between the second heat dissipation structure 142 and the second air inlet 102.

In the embodiment, the first heat dissipation structure 141 and the second heat dissipation structure 142 are, for example, heat sinks respectively, wherein the first heat dissipation structure 141 and the second heat dissipation structure 142 are respectively connected to the light source module 110 and the light valve module 120 via a heat conducting member 143, for example. In the embodiment, the heat conducting member 143 is, for example, a heat pipe. However, the invention does not limit the structures and types of the first heat dissipation structure 141, the second heat dissipation structure 142, and the heat conducting member 143. In different embodiments, the structures, types, and configurations of the first heat dissipation structure 141, the second heat dissipation structure 142, and the heat conducting member 143 may be adjusted according to requirements.

Referring to FIG. 2, in the embodiment, in the structural design of the fan 150, the area of the first air exhaust 151 and the area of the second air exhaust 152 are different, so that the fan 150 has better heat dissipation performance. In other embodiments, the area of the first air exhaust 151 and the area of the second air exhaust 152 may be the same.

Referring to FIG. 2, in an embodiment, the area of the first air inlet 101 and the area of the second air inlet 102 of the casing 105 correspond to the first heat dissipation structure 141 and the second heat dissipation structure 142 respectively, so that the projection device 100 has better heat dissipation performance.

Referring to FIG. 2, in the embodiment, the area of the first air inlet 101 and the area of the second air inlet 102 of the casing 105 are greater than the area of the first air outlet 103 and the area of the second air outlet 104 of the casing 105, so that the projection device 100 has better heat dissipation performance.

FIG. 3 is a schematic side perspective view of the projection device 100 of FIG. 1. Please refer to FIG. 2 and FIG. 3 at the same time, in the embodiment, the casing 105 includes an upper cover portion 106 (shown in FIG. 3), a lower cover portion 107 (shown in FIG. 3), and a side cover portion 108 connected between the upper cover portion 106 and the lower cover portion 107. The first air inlet 101 (shown in FIG. 2), the first air outlet 103 (shown in FIG. 2), the second air inlet 102, and the second air outlet 104 are located on the side cover portion 108 respectively, and the side cover portion 108 includes a front cover SW1 and a rear cover SW2 parallel to each other (parallel to the XZ plane) and a left cover SW3 and a right cover SW4 parallel to each other (parallel to the YZ plane). In the embodiment, the first air inlet 101 and the second air inlet 102 are located on the adjacent front cover SW1 and left cover SW3 respectively. The first air outlet 103 and the second air outlet 104 are located on the adjacent rear cover SW2 and right cover SW4 respectively.

Specifically, referring to FIG. 2, in the embodiment, the range of the orthographic projection of the first air exhaust 151 at the front cover SW1 is at least partially overlapped with the range of the orthographic projection of the first air inlet 101 at the front cover SW1 and the range of the orthographic projection of the first air outlet 103 at the front cover SW1, and the range of the orthographic projection of the second air exhaust 152 at the left cover SW3 is at least partially overlapped with the range of the orthographic projection of the second air inlet 102 at the left cover SW3 and the range of the orthographic projection of the second air outlet 104 at the left cover SW3. In addition, the areas of the first air outlet 103 and the second air outlet 104 of the casing 105 are greater than or equal to the areas of the first air exhaust 151 and the second air exhaust 152 of the fan 150. The range of the orthographic projection of the first air outlet 103 at the front cover SW1 is at least partially overlapped with the range of the orthographic projection of the first air inlet 101 at the front cover SW1. The range of the orthographic projection of the second air outlet 104 at the left cover SW3 is at least partially overlapped with the range of the orthographic projection of the second air inlet 102 at the left cover SW3.

Via the design of the dual air exhausts (i.e., the first air exhaust 151 and the second air exhaust 152) of the fan 150 directly facing the dual air outlets (i.e., the first air outlet 103 and the second air outlet 104) of the casing 105, not only is the air exhaust area of the dual air exhausts of the fan 150 facing the dual air outlets of the casing 105 increased, but also two main flow fields F1 and F2 are substantially parallel to the Y-axis and the X-axis respectively. Therefore, the air flow path in the casing 105 is shortened, thereby effectively reducing the air flow resistance in the casing 105 and increasing the airflow amount in the casing 105. In particular, the main flow field F1 is the airflow flowing out of the first air outlet 103 from the first air inlet 101 via the first air exhaust 151, and a main flow field F12 is the airflow flowing out of the second air outlet 104 from the second air inlet 102 via the second air exhaust 152.

Accordingly, compared to a conventional projection device in which a fan (not shown) with a single air exhaust and an air duct (not shown) are disposed in the casing (not shown) and the structural configuration of a casing (not shown) with a plurality of air outlets, the projection device 100 of the embodiment has advantages in terms of cost and space utilization.

Please refer to FIG. 3, in the embodiment, the projection device 100 further includes a first circuit board 160 and a second circuit board 180. The first circuit board 160 is disposed between the upper cover portion 106 and the fan 150 in the Z-axis direction, and the second circuit board 180 is disposed between the second heat dissipation structure 142 and the fan 150 in the X-axis direction.

Please refer to FIG. 3, in the embodiment, the projection device 100 further includes a pillar 170. The fan 150 also has a first air intake 153 and a second air intake 154, and the fan 150 is connected to the lower cover portion 107 of the casing 105 in the Z-axis direction via the pillar 170. More specifically, the number of the pillars 170 is two, and the pillars 170 are respectively disposed at two sides of the fan 150. The pillars 170 enable both the first air intake 153 and the second air intake 154 of the fan 150 to suck in the thermal field (not shown) passing through the first heat dissipation structure 141 and the second heat dissipation structure 142. Here, the area of the first air intake 153 is different from the area of the second air intake 154 so that the projection device 100 has better heat dissipation performance.

Please refer to FIG. 3, in the embodiment, in the structural design of the casing 105, the upper cover portion 106, and the lower cover portion 107 are disposed in parallel. The fan 150 includes a first surface S1 and a second surface S2 corresponding to and parallel to the upper cover portion 106 and the lower cover portion 107 respectively, and the first air intake 153 and the second air intake 154 are located on the first surface S1 and the second surface S2 respectively.

In more detail, the distance from the first surface S1 of the fan 150 to the upper cover portion 106 of the casing 105 is a first distance D1, and the distance from the second surface S2 of the fan 150 to the lower cover portion 107 of the casing 105 is a second distance D2. Moreover, the ratio of the first distance D1 to the second distance D2 is 0.8 to 1.2 times the ratio of the area of the first air intake 153 to the area of the second air intake 154 of the fan 150. In other words, the first air intake 153 and the second air intake 154 of the fan 150 maintain a certain distance from the casing 105 respectively, and the first distance D1 and the second distance D2 correspond to the area of the first air intake 153 and the area of the second air intake 154 respectively, so that the intake air flow of the fan 150 is not blocked by the casing 105 or other elements, so that the projection device 100 has better heat dissipation performance.

Referring to FIG. 3, in the embodiment, a thickness T1 of the fan 150 is less than a thickness T2 of the first heat dissipation structure 141 and a thickness T3 of the second heat dissipation structure 142 of the heat dissipation module 140 in the direction of gravity (i.e., −Z-axis direction) of the projection device 100. Accordingly, it may be ensured that the thermal field (not shown) flowing through the first heat dissipation structure 141 or the second heat dissipation structure 142 flows in via the first air intake 153 and the second air intake 154 of the fan 150, and is discharged out of the projection device 100 from the first air outlet 103 (shown in FIG. 2) and the second air outlet 104 of the casing 105, so that the projection device 100 has better heat dissipation performance.

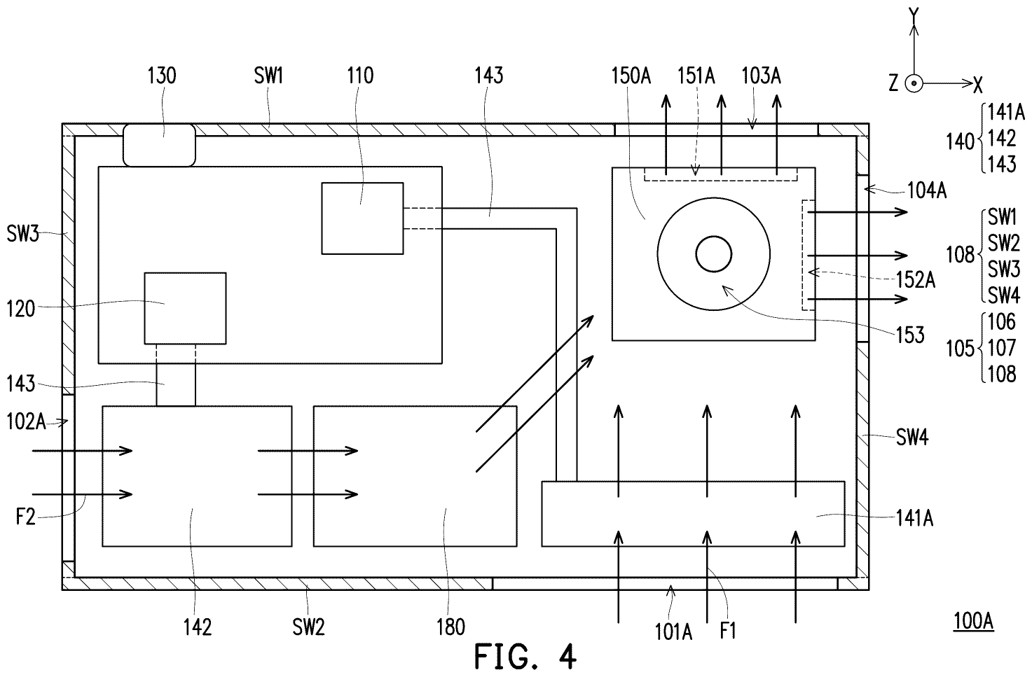

Referring to FIG. 4, FIG. 4 is a schematic top perspective view of a projection device of another embodiment of the invention. The structure and advantages of a projection device 100A of FIG. 4 are similar to the projection device 100 of FIG. 2, and only the differences are described below. In the embodiment, a first air inlet 101A of the casing 105 is located on the rear cover SW2, and a first air outlet 103A is located on the front cover SW1. A first heat dissipation structure 141A is disposed at a position adjacent to the first air inlet 101A of the casing 105. A fan 150A is disposed at a position adjacent to the first air outlet 103A of the front cover SW1 of the casing 105. More specifically, a first air exhaust 151A and a second air exhaust 152A of the fan 150A are respectively disposed at positions adjacent to the first air outlet 103A and the second air outlet 104A of the casing. The range of the orthographic projection of the first air exhaust 151A at the front cover SW1 is at least partially overlapped with the range of the orthographic projection of the first air inlet 101A at the front cover SW1 and the range of the orthographic projection of the first air outlet 103A at the front cover SW1.

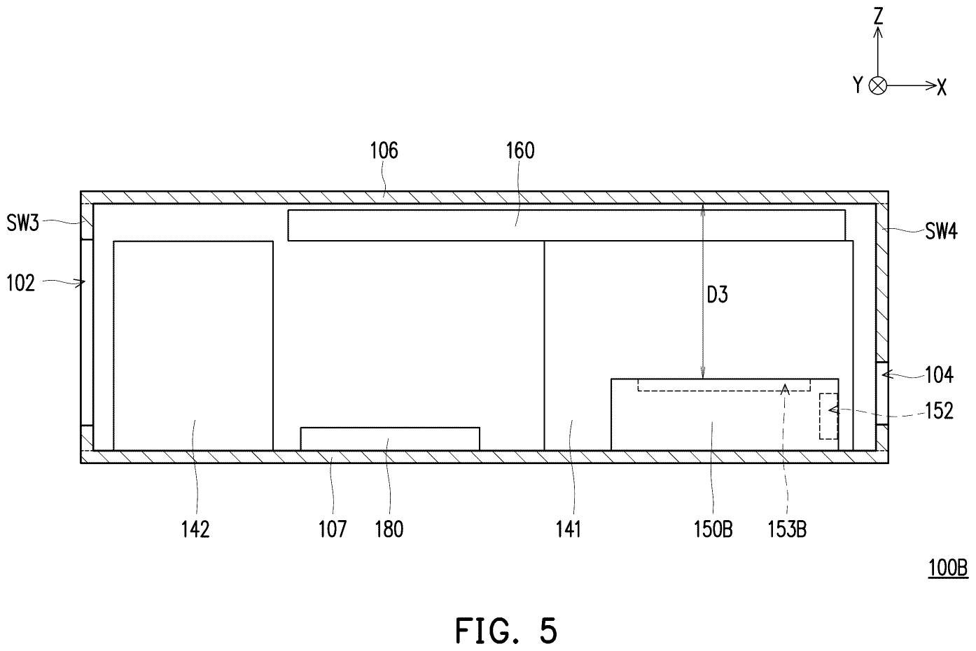

Referring to FIG. 5, FIG. 5 is a schematic side perspective view of a projection device of another embodiment of the invention. The structure and advantages of a projection device 100B of FIG. 5 are similar to the projection device 100 of FIG. 3, and only the differences are described below. In the embodiment, a fan 150B of the projection device 100B only has a first air intake 153B (i.e., a single air intake), that is, the fan 150B is a fan 150B with a single-sided air intake and double-sided air exhaust design. The fan 150B of FIG. 5 rests on the lower cover portion 107 of the casing 105, the first air intake 153B faces the upper cover portion 106, and there is a distance D3 between the first air intake 153B and the upper cover portion 106 to ensure that a thermal field (not shown) flows in from the first air intake 153B.

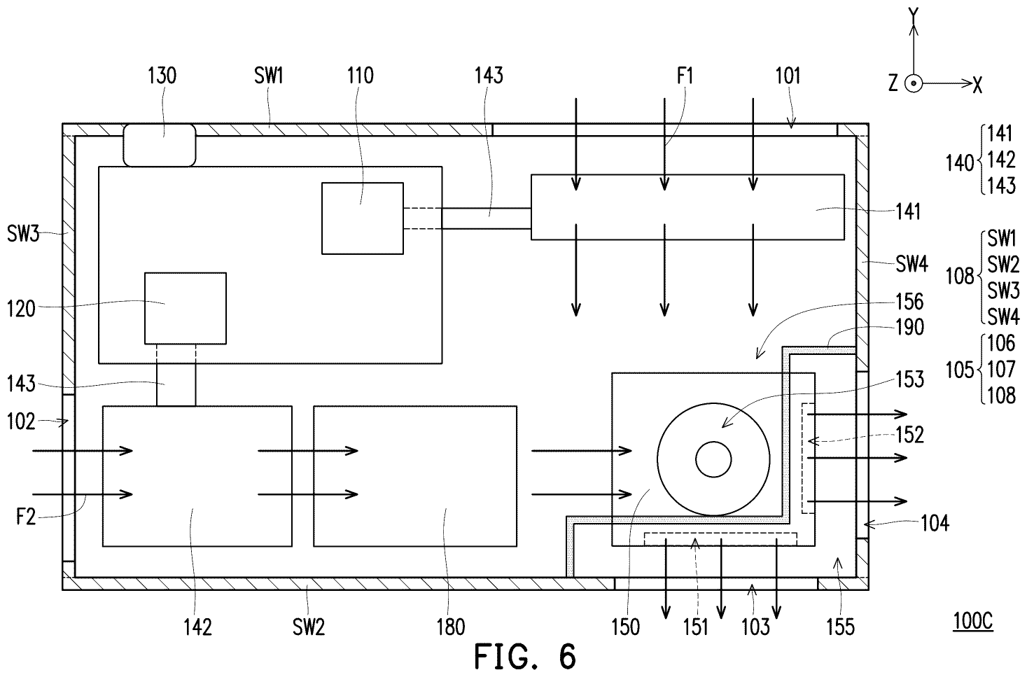

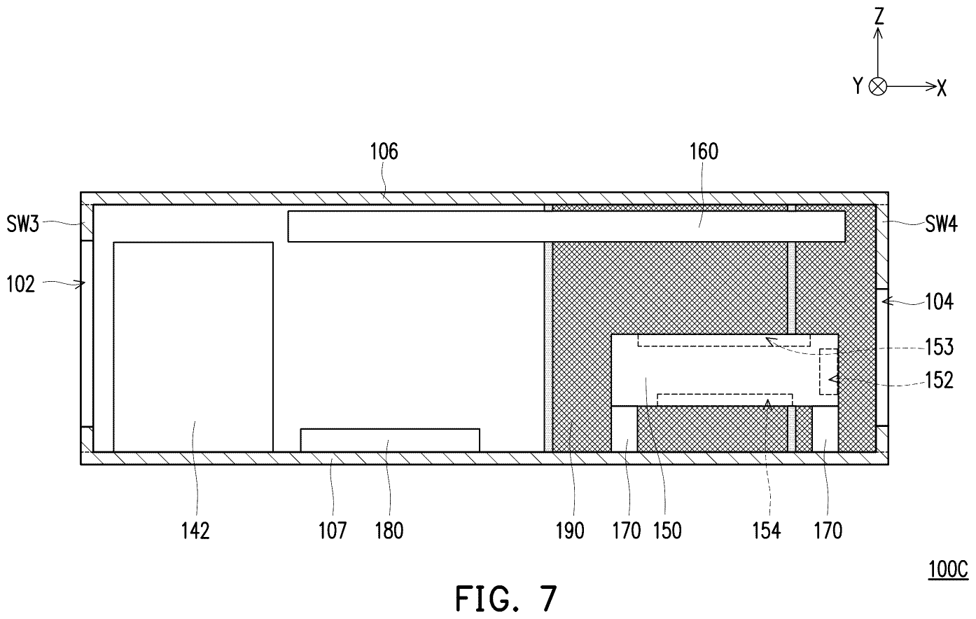

Referring to FIG. 6, FIG. 6 is a schematic top perspective view of a projection device of another embodiment of the invention. The structure and advantages of a projection device 100C of FIG. 6 are similar to the projection device 100 of FIG. 2, and only the differences are described below. In the embodiment, the projection device 100C further includes a partition 190. The partition 190 is disposed between the fan 150 and the casing 105 to block the air exhaust area 155 and the air intake area 156 of the fan 150, wherein the first air exhaust 151 and the second air exhaust 152 are located at the air exhaust area 155, and the first air intake 153 and the second air intake 154 (not shown) are located at the air intake area 156. More specifically, please refer to FIG. 7. FIG. 7 is a schematic side perspective view of the projection device of FIG. 6. The partition 190 is disposed between the fan 150 and the upper cover portion 106 and the lower cover portion 107 of the casing 105. Here, in the projection device 100C, for example, a sealant is used to fix the partition 190 and the adjacent fan 150, the casing 105, and adjacent members.

Accordingly, via the disposition of the partition 190, the thermal field (not shown) discharged from the first air exhaust 151 and the second air exhaust 152 may be prevented from further being sucked in by the first air intake 153 or the second air intake 154 (not shown) of the fan 150 and generating backflow and occupying the flow of the fan 150. That is, the reduction of the air volume sucked by the fan 150 from the thermal field (not shown) of the first heat dissipation structure 141 or the second heat dissipation structure 142 may be avoided. Therefore, the disposition of the partition 190 may provide the projection device 100C with better heat dissipation performance.

Based on the above, the embodiments of the invention have at least one of the following advantages or efficacies. In the projection device of the invention, via the structural configuration of the casing and the fan, the double air exhausts (i.e., the first air exhaust and the second air exhaust) of the fan are respectively disposed at positions adjacent to the double air outlets (i.e., the first air outlet and the second air outlet) of the casing, and by optimizing the flow field path in the casing while maintaining the volume of the thin casing, the air flow resistance in the casing may be effectively reduced and the air flow amount in the casing may be increased at the same time, so that the projection device has good heat dissipation capability.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, wherein the projection device comprises a casing and a light source module, a light valve module, a projection lens, a heat dissipation module, and a fan disposed in the casing, wherein:
the light source module is configured to provide an illumination beam;
the light valve module is disposed on a transmission path of the illumination beam and configured to convert the illumination beam into an image beam;
the projection lens is disposed on a transmission path of the image beam and configured to project the image beam out of the projection device;
the casing has at least one air inlet, a first air outlet, and a second air outlet;
the heat dissipation module is coupled to the light source module and the light valve module and configured to cool the light source module and the light valve module; and
the fan has a first air exhaust and a second air exhaust, and the first air exhaust and the second air exhaust are respectively disposed at positions adjacent to the first air outlet and the second air outlet of the casing.

2. The projection device of claim 1, wherein the heat dissipation module comprises a first heat dissipation structure and a second heat dissipation structure, the first heat dissipation structure is coupled to the light source module, and the second heat dissipation structure is coupled to the light valve module.

3. The projection device of claim 2, wherein the at least one air inlet comprises a first air inlet and a second air inlet, the first heat dissipation structure is disposed at a position adjacent to the first air inlet of the casing, and the second heat dissipation structure is disposed at a position adjacent to the second air inlet of the casing.

4. The projection device of claim 1, wherein areas of the first air exhaust and the second air exhaust are different.

5. The projection device of claim 1, wherein areas of the first air exhaust and the second air exhaust are the same.

6. The projection device of claim 1, further comprising a pillar, wherein the fan further has a first air intake and a second air intake, and the fan is connected to the casing via the pillar.

7. The projection device of claim 6, wherein an area of the first air intake is different from an area of the second air intake.

8. The projection device of claim 6, wherein the casing comprises an upper cover portion, a lower cover portion, and a side cover portion connected between the upper cover portion and the lower cover portion, the upper cover portion and the lower cover portion are disposed in parallel, the fan comprises a first surface and a second surface respectively corresponding to and parallel to the upper cover portion and the lower cover portion, and the first air intake and the second air intake are respectively located on the first surface and the second surface.

9. The projection device of claim 8, wherein a distance from the first surface to the upper cover portion is a first distance, a distance from the second surface to the lower cover portion is a second distance, and a ratio of the first distance to the second distance is 0.8 times to 1.2 times a ratio of an area of the first air intake to an area of the second air intake.

10. The projection device of claim 1, wherein the at least one air inlet comprises a first air inlet and a second air inlet, and areas of the first air inlet and the second air inlet are greater than areas of the first air outlet and the second air outlet.

11. The projection device of claim 1, wherein the casing comprises an upper cover portion, a lower cover portion, and a side cover portion connected between the upper cover portion and the lower cover portion, the at least one air inlet comprises a first air inlet and a second air inlet, the first air inlet, the first air outlet, the second air inlet, and the second air outlet are respectively located on the side cover portion, the side cover portion comprises a front cover and a rear cover parallel to each other and a left cover and a right cover parallel to each other, and a range of an orthographic projection of the first air exhaust at the front cover is at least partially overlapped with a range of orthographic projections of the first air inlet and the first air outlet at the front cover.

12. The projection device of claim 11, wherein a range of an orthographic projection of the second air exhaust at the left cover is at least partially overlapped with a range of orthographic projections of the second air inlet and the second air outlet at the left cover.

13. The projection device of claim 1, wherein along a direction of gravity, a thickness of the fan is less than a thickness of the heat dissipation module.

14. The projection device of claim 1, further comprising a partition, wherein the fan has at least one air intake, the partition is disposed between the fan and the casing, and the partition is configured to block an air exhaust area and an air intake area of the fan, wherein the first air exhaust and the second air exhaust are located at the air exhaust area, and the at least one air intake is located at the air intake area.

15. The projection device of claim 1, further comprising a circuit board, wherein the casing comprises an upper cover portion, a lower cover portion, and a side cover portion connected between the upper cover portion and the lower cover portion, and the circuit board is disposed between the upper cover portion and the fan.

16. The projection device of claim 1, wherein the fan also has a first air intake, the casing comprises an upper cover portion, a lower cover portion, and a side cover portion connected between the upper cover portion and the lower cover portion, the first air intake faces the upper cover portion, and there is a distance between the first air intake and the upper cover portion.

17. The projection device of claim 1, wherein areas of the first air outlet and the second air outlet of the casing is greater than or equal to areas of the first air exhaust and the second air exhaust of the fan.
